(19) United States
(12) Patent Application Publication
(10) Pub. No.: US 2018/0245023 A1
(43) Pub. Date: Aug. 30, 2018

(54) LIQUID DETERGENCY COMPOSITION COMPRISING PROTEASE AND NON-PROTEASE ENZYME

(71) Applicant: Conopco, Inc., d/b/a UNILEVER, Englewood Cliffs, NJ (US)

(72) Inventors: Simone Antonio De Rose, Exeter (GB); Andrew DOWD, Bebington, Wirral (GB); Dietmar Andreas LANG, Liverpool (GB); Jennifer Ann LITTLECHILD-BOND, Tiverton (GB); Halina Rose NOVAK, Merelbeke (BE); Neil James PARRY, Tarporley (GB); Sukriti SINGH, Bromborough, Wirral (GB)

(73) Assignee: Conopco, Inc., d/b/a UNILEVER, Englewood Cliffs, NJ (US)

(21) Appl. No.: 15/753,770

(22) PCT Filed: Aug. 25, 2016
(86) PCT No.: PCT/EP2016/070092

§ 371 Date: Feb. 20, 2018

(30) Foreign Application Priority Data
Aug. 28, 2015 (EP) EP15182934.8
Aug. 28, 2015 (EP) EP15182936.3
Aug. 28, 2015 (EP) EP15182937.1

(51) Int. Cl. C11D 3/386; C11D 1/83

(52) U.S. Cl. CPC C11D 3/38618; C11D 1/72; C11D 1/83; C11D 3/38627

(57) ABSTRACT

A liquid detergency composition comprising: protease and non-protease enzyme wherein at least part of either the protease or the non-protease enzyme is cross-linked enzyme aggregate.

Liquid detergency compositions comprising enzymes have become more prevalent over the last few years. In particular liquid detergency products comprising lipases and proteases have found use for more effective removal of fat- and protein-based stains.

However, a major problem in using such enzymes in liquid detergency compositions is that they are prone to decrease in enzyme activity over the life time of the liquid detergency composition, leading to reduced stain removal efficiency. A further problem in formulating multi-enzyme liquid detergency compositions comprising protease is the tendency of the protease to inactivate other enzymes in the composition by proteolytic attack. One way of increasing enzyme activity is to simply add more enzyme to the detergency composition, but this leads to cost increase. Indeed the detergency composition market although being a high volume market tends to have low profit margin due to ingredient costs.

Another way of maintaining enzyme activity over the shelf-life of a detergency composition is by use of crystallized enzymes. Such crystallized enzymes are described in US2002/0137156, US2002/0082181 and US2001/0046493.

However, crystallized enzymes are more expensive than their non-crystallized counterparts and also their manufacture itself is a time-consuming and laborious process. As such, use of crystallized enzymes to maintain the stability and activity of enzymes in a liquid detergency composition is not a useful technology.

Alternatively, binding enzymes to a scaffold, such as an activated polymer (U.S. Pat. No. 6,030,933) or non-material surface (US2007/077565) or activated substrate (US2004/0029242) has also been described. Again, use of such scaffolds and the additional step of binding the enzymes thereto increases costs and enzyme-preparation complexity. Therefore these are also considered not useful technologies to prepare liquid detergency compositions comprising enzymes.

US2008/0296231 discloses a method for the preparation of cross-linked enzyme aggregates (CLEAs) that allows use of a wider range of reagents and the possibility to obtain enzyme aggregates with improved properties (US2008/0296231). Cross-linked enzyme aggregates of many enzymes, such as lipase CLEAs are commercially available (e.g. from Sigma Aldrich or Novozymes).

It is an object of the present invention to provide a simple and cost-effective liquid detergency composition comprising protease and a non-protease enzyme, wherein the non-protease enzyme shows improved stability and activity during storage conditions.

### SUMMARY OF THE INVENTION

One or more of the above objectives have been met by a liquid detergency composition comprising a non-protease enzyme and a protease, wherein either the non-protease enzyme or the protease (but not both) are in the form of a cross-linked enzyme aggregate (CLEA). Such liquid detergency compositions comprising non-protease enzyme and protease were found to be more stable then compositions wherein both the non-protease enzyme and the protease enzyme were in the form of CLEA or wherein both were in free (i.e. soluble) form.

Therefore, in a first aspect the invention relates to a liquid detergency composition comprising:
protease and non-protease enzyme wherein at least part of either the protease or the non-protease enzyme is cross-linked enzyme aggregate (i.e. but not both).

### DETAILED DESCRIPTION

All percentages mentioned herein are by weight calculated on the total composition, unless specified otherwise. The abbreviation ‘wt. %’ is to be understood as % by weight of the total composition unless otherwise specified. It will be appreciated that the total amount of ingredients in the detergency composition will not exceed 100 wt. %.

### Protease

The liquid detergency composition according to the invention comprises one or more proteases. Preferred proteases are serine proteases or metallo proteases, more preferably an alkaline microbial protease or a trypsin-like protease. More preferred (commercially available) proteases are Alcalase™, Savinase™ Primase™, Duralase™, Dyrazym™, Esperase™, Everlase™, Polarzyme™ Kannase™ and Coronase™, Relase™, (Novozymes A/S), Maxatase™ Maxacal™, Maxapem™, Properase™, Purafect™, Purafect OxP™, FN2™, and FN3™ (Genencor International Inc.). Especially good results were obtained for liquid detergency compositions wherein the protease is Savinase™, Coronase™ and/or Relase™. Therefore, still even more preferably the liquid detergency composition according to the invention comprises Savinase™, Coronase™ Relase™ or mixtures thereof, and more preferably essentially is Relase™.

Preferably the amount of protease is from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. %.

### Non-Protease Enzyme

The non-protease enzyme is an enzyme having little or no proteolytic activity as understood by the person skilled in the art. The non-protease enzyme can be a single non-protease enzyme or a mixture of non-protease enzymes. Preferably, the liquid detergency composition according to the invention comprises a non-protease enzyme selected from one or more enzymes of lipase, amylase, phospholyase, cutinase, cellulose, peroxidise, oxidase, pectate lyase and mannase enzymes, more preferably lipase.

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. % of lipase, based on the total weight of the composition.

Said lipase can be any known lipase used in the art of detergency compositions. Preferred are lipases from Humicola (synonym Thermomyces), e.g. from other H. lanuginosa (T. lanuginosus) strains or from H. insolens, a Pseudomonas lipase, e.g. from P. alcaligenes or P. pseudoalcaligenes, P. cepacia, P. stutzeri, P. fluorescens, Pseudomonas sp. strain SD 705 (WO 95/06720 and WO 96/27002), P. wisconsinensis, a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Even more preferred (commercially available) lipases are Lipex™, Lipolase™ and Lipolase Ultra™, and the Bacterial enzyme, Lipomax® ex Genecor. This is a bacterially derived Lipase, of variant M21L of the lipase of Pseudomonas alcaligenes as described in WO 94/25578 to Gist-Brocades (M. M. M. J. Cox, H. B. M. Lenting, L. J. S. M. Mulleners and J. M. van der Laan).

Particularly good stability results were obtained when the lipase comprises a polypeptide having an amino acid sequence which has at least 90 percent sequence identity with the wild-type lipase derived from Humicola lanuginosa strain DSM 4109 and compared to said wild-type lipase, comprises a substitution of an electrically neutral or negatively charged amino acid within 15 A of E1 or Q249 with a positively charged amino acid. Said lipase preferably comprises one or more of the following:

(I) a peptide addition at the C-terminal;
(II) a peptide addition at the N-terminal;
(III) the following limitations:
i. comprises a negatively charged amino acid in position E210 of said wild-type lipase;
ii comprises a negatively charged amino acid in the region corresponding to positions 90-101 of said wild-type lipase; and
iii. comprises a neutral or negatively charged amino acid at a position corresponding to N94 of said wild-type lipase; and/or
iv. has a negative charge or neutral charge in the region corresponding to positions 90-101 of said wild-type lipase; and

These are available under the Lipex™ brand from Novozymes and are still even more preferred.

The non-protease enzyme according to the invention preferably comprises one or more amylases. Preferred amylases (alpha and/or beta) include those of bacterial or fungal origin. Chemically modified or protein engineered mutants are included. More preferred amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Even more preferred (commercially available) amylases are Duramyl™, Termamyl™, Termamyl Ultra™, Natalase™, Stainzyme™ Fungamyl™ and BAN™ (Novozymes A/S), Rapidase™ and Purastar™ (from Genencor International Inc.), Stainzyme™ and Resilience™ (Novozymes).

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. % of amylase, based of the total weight of the composition.

The non-protease enzyme according to the invention preferably comprises one or more phospholipases. Phospholipase are classified as EC 3.1.1.4 and/or EC 3.1.1.32. As used herein, the term phospholipase is an enzyme, which has activity towards phospholipids. Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A1 and A2 which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. % of phospholipase, based of the total weight of the composition.

The non-protease enzyme preferably comprises one or more cutinases. Cutinases are classified in EC 3.1.1.74. Cutinases are classified in EC 3.1.1.74. The cutinase used according to the invention may be of any origin. Preferably the cutinases are of microbial origin and more preferably of bacterial, of fungal or of yeast origin.

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. % of cutinase, based of the total weight of the composition.

The non-protease enzyme preferably comprises one or more cellulases. Preferred cellulase include those of bacterial, fungal, insect and/or mammalian origin. Chemically modified or protein engineered mutants are included. More preferred are cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. No. 4,435,307, U.S. Pat. No. 5,648,263, U.S. Pat. No. 5,691,178, U.S. Pat. No. 5,776,757, WO 89/09259, WO 96/029397, and WO 98/012307. Even more preferred (commercially available) cellulases are Celluzyme™, Carezyme™, Endolase™, Renozyme™ (Novozymes NS), Clazinase™ and Puradax HA™ (Genencor International Inc.), and KAC-500(B)™ (Kao Corporation).

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. % of cellulase, based of the total weight of the composition.

The non-protease enzyme preferably comprises one or more peroxidases/oxidases, preferably these are of bacterial, fungal or mammalian origin and more preferably of bacterial origin. Chemically modified or protein engineered mutants are included. Preferably the peroxidases/oxidases are derived from Aeromonas sp.

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. % of peroxidase/oxidase, based of the total weight of the composition.

The non-protease enzyme preferably comprises one or more pectate lyases (also called polygalacturonate lyases). Preferred are pectate lyases that have been derived from bacterial genera such as Erwinia, Pseudomonas, Klebsiella and Xanthomonas, Bacillus. More preferred are pectate lyases obtained from Bacillus subtilis (Nasser et al. (1993) FEBS Letts. 335:319-326), Bacillus sp. YA-14 (Kim et al. (1994) Biosci. Biotech. Biochem. 58:947-949); Bacillus pumilus (Dave and Vaughn (1971) J. Bacteriol. 108:166-174), B. polymyxa (Nagel and Vaughn (1961) Arch. Biochem. Biophys. 93:344-352), B. stearothermophilus (Karbassi and Vaughn (1980) Can. J. Microbiol. 26:377-384), Bacillus sp. (Hasegawa and Nagel (1966) J. Food Sci. 31:838-845), Bacillus sp. RK9 (Kelly and Fogarty (1978) Can. J. Microbiol. 24:1164-1172), as disclosed in Heffron et al., (1995) Mol. Plant-Microbe Interact. 8: 331-334, Henrissat et al., (1995) Plant Physiol. 107: 963-976, as disclosed in WO 99/27083, WO 99/27084, U.S. Pat. No. 6,284,524 (which document is hereby incorporated by reference), WO 02/006442 (in particular as disclosed in the Examples, which document is hereby incorporated by reference). Even more preferred (commercially available) pectate lyases are BIOPREP™ and SCOURZYME™ L from Novozymes A/S, Denmark.

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. % of pectate lyase, based of the total weight of the composition.

The non-protease enzyme preferably comprises one or more mannanases (EC 3.2.1.78). Preferred mannanases include mannanases of bacterial and fungal origin. More preferred are mannases derived from filamentous fungus genus Aspergillus, preferably Aspergillus niger or Aspergillus aculeatus (WO 94/25576); Trichoderma reseei (as disclosed in WO 93/24622); Bacillus organisms (e.g. as described in Talbot et al., Appl. Environ. Microbiol., Vol. 56, No. 11, pp. 3505-3510 (1990), which describes a beta-mannanase derived from Bacillus stearothermophilus, Mendoza et al., World J. Microbiol. Biotech., Vol. 10, No. 5, pp. 551-555 (1994), which describes a beta-mannanase derived from Bacillus subtilis, JP-A-03047076 which describes a beta-mannanase derived from Bacillus sp., JP-A-63056289 which describes the production of an alkaline, thermostable beta-mannanase, JP-A-63036775 which describes Bacillus microorganism FERM P-8856 which produces beta-mannanase and beta-mannosidase, JP-A-08051975 which describes a alkaline beta-mannanases from alkalophilic Bacillus sp. AM-001, WO97/11164 which described a purified mannanase from Bacillus amyloliquefaciens, WO 91/18974 which describes a hemicellulase such as a glucanase, xylanase or mannanase active). Also preferred are the alkaline family 5 and 26 mannanases derived from Bacillus agaradhaerens, Bacillus licheniformis, Bacillus halodurans, Bacillus clausii, Bacillus sp., and Humicola insolens (as disclosed in WO 99/64619). More preferred bacterial mannases are those described in WO 99/64619. Even more preferred (commercially available) mannanase is Mannaway™ available from Novozymes NS Denmark.

Preferably the non-protease enzyme comprises from 0.01 to 6 wt. %, more preferably from 0.1 to 5 wt. %, even more preferably from 0.2 to 4 wt. %, still even more preferably from 0.5 to 3 wt. % and still even more preferably from 0.7 to 2.0 wt. %. of mannase, based of the total weight of the composition.

Preferably at least 25 wt. %, more preferably at least 50 wt. % and even more preferably at least 75 wt. %, based on the total weight of non-protease enzyme, is lipase.

Preferably the liquid detergency composition according to the invention is ambient-active.

### CLEA

CLEAs of the lipase according to the invention can be prepared using any suitable technique known in the art, such as described in EP1088887 using a di-aldehyde as cross-linking agent.

A more preferred method of making the CLEA of lipase according to the invention comprises the following steps:

1) Providing an aqueous suspension of the enzyme, preferably at room temperature and in a suitable buffer. The buffer preferably is a buffer of MES-NaOH, NaCl and CaCl2 having a pH of 6 to 9. More preferably the buffer has from 20 to 50 mM of MES-NaOH, from 100 to 200 mM of NaCl and/or 0.5 to 2 mM of CaCl2. The enzyme concentration preferably is from 0.3 to 2 μM.
2) Addition of a suitable activator agent to bring the enzyme in an active state. This will further increase the activity of the enzyme CLEA. In the case of lipase the activator agent preferably is an emulsifier, more preferably a polysorbate and even more preferably Tween 80 (i.e. polyoxyethylene (20) sorbitan. Preferably the concentration of the activator agent is from 10 to 30 mM. Preferably the mixture is stirred, such as at room temperature, for at least 1 minute.
3) Cross-linking the enzyme by addition of a di-aldehyde. The cross-linking agent preferably is one or more of glutaraldehyde, glyoxal, malondialdehyde, succindialdehyde, phthaladehyde, and more preferably is glutaraldehyde. With glutaraldehyde as cross-linking agent especially good results were obtained. Preferably the cross-linking is performed by glutaraldehyde in the presence of ammonium sulphate. Preferably the ammonium sulphate is added first and the mixture stirred for at least 20 seconds before addition of the glutaraldehyde. Preferably the amount of ammonium sulphate at step 3) is from 30 to 95 wt. %, more preferably from 50 to 90 wt. % and even more preferably from 70 to 85 wt. %, based on the weight of the mixture at step 3). Preferably the amount of di-aldehyde at step 3) is from 0.1 to 200 mM, more preferably from 1 to 50 mM, even more preferably of from 2 to 30 mM and still even more preferably of from 10 to 21 mM.
4) Preferably the reaction mixture is stirred for at least 1 hour, more preferably from 4 to 30 hours and even more preferably from 10 to 20 hours. The temperature for stirring the reaction mixture is preferably below ambient temperature and more preferably from 1 to 15 degrees Celsius.
5) Preferably the CLEAs are washed. More preferably the CLEAs are washed by addition of water and mixing. Preferably after washing the CLEAs are isolated. The isolation of the CLEAs can suitably be performed by centrifugation at conditions suitable to collect separate the CLEAs from the bulk of the liquid phase, and decanting to remove the bulk of said liquid phase. The washing step can be repeated more than once and preferably is repeated from 2 to 4 times.
6) Preferably the isolated and washed CLEAs are re-suspended in a suitable buffer (preferably a buffer as in step 1) before use. The isolated and washed CLEAs are preferably stored at cool and/or dark conditions.

As mentioned, either the protease or the non-protease enzyme is in the form of a CLEA (but not both). Preferably the protease is in the form of a CLEA as exceptionally good results were obtained regarding the stability of the non-protease enzyme (i.e. which in this preferred case is in soluble form).

In case the protease is present in soluble form, preferably at least 25 wt. %, more preferably at least 50 wt. %, even more preferably 75 wt. % and still even more preferably essentially all the non-protease enzyme, based on the total weight of the non-protease enzyme, is in the form of a cross-linked enzyme aggregate.

In case the non-protease enzyme is present in soluble form, preferably at least 25 wt. %, more preferably at least 50 wt. %, even more preferably 75 wt. % and still even more preferably essentially all of the protease, based on the total weight of the protease is in the form of a cross-linked enzyme aggregate.

### Surfactant

The liquid detergency composition according to the invention preferably comprises surfactant and more preferably comprises detersive surfactant. By detersive surfactant is meant that the surfactant provides a detersive (i.e. cleaning effect) to textile fabrics treated as part of a cleaning, preferably a laundering, process.

Preferably the total amount of surfactant present in the liquid detergency composition is from 2 to 85 wt. %, more preferably from 3 to 60 wt. %, even more preferably from 4 to 40 wt. % and still even more preferably from 5 to 35 wt. %.

Preferably the detersive surfactant comprises anionic surfactant, nonionic surfactant or a mixture thereof and more preferably comprises anionic and nonionic surfactants.

The surfactant preferably comprises biosurfactant and more preferably biosurfactant derived from bacteria, fungi and/or other microbes. The surfactant preferably comprises one or more of glycolipid biosurfactant (which preferably is a rhamnolipid or sophorolipid or trehalolipid or a mannosylerythritol lipid (MEL)), cellobiose, peptide based biosurfactants, lipoproteins and lipopeptides e.g. surfactin, fatty acids e.g. corynomucolic acids (preferably with hydrocarbon chain C12-C14), phospholipids (preferred phospholipids are phosphatidylethanolamine produced by Rhodococcus erythropolis grown on n-alkane which results in lowering of interfacial tension between water and hexadecane to less than 1 mN m-1 and CMC of 30 mg L-1 (Kretschner et al., 1982) and spiculisporic acid); polymeric biosurfactants including emulsan, liposan, mannoprotein and polysaccharide-protein complexes. Preferably the biosurfactant comprises a rhamnolipid.

The amount of anionic surfactant or nonionic surfactant or the combination thereof preferably is from 0.5 to 95 wt. %, more preferably from 1 to 50 wt. % and even more preferably from 1.5 to 25 wt. %, based on total weight of surfactant. If a detersive surfactant mixture is used that incorporates both anionic and nonionic surfactants, then preferably the ratio of anionic surfactant to nonionic surfactant is from 10:1 to 1:10.

### Nonionic Surfactant

‘Nonionic surfactant’ is defined as amphiphilic molecules with a molecular weight of less than about 10,000, unless otherwise noted, which are substantially free of any functional groups that exhibit a net charge at the normal wash pH of 6-11.

Any type of nonionic surfactant may be used. Nonionic surfactants preferably are fatty acid alkoxylates and more preferably ethoxylates. Preferred ethoxylates have an alkyl chain of from C₈-C₃₅, more preferably C₁₀-C₂₄, and have preferably 3 to 25, more preferred 5 to 15 ethylene oxide groups. These are commercially available such as under Neodols from Shell (The Hague, The Netherlands); ethylene oxide/propylene oxide block polymers which may have molecular weight from 1,000 to 30,000, for example, Pluronic (trademark) from BASF (Ludwigshafen, Germany); and alkylphenol ethoxylates, for example Triton X-100, available from Dow Chemical (Midland, Mich., USA).

### Anionic Surfactant

‘Anionic surfactants’ are defined as amphiphilic molecules comprising one or more functional groups that exhibit a net anionic charge when in aqueous solution at the normal wash pH of between 6 and 11.

Preferred anionic surfactants are the alkali metal salts of organic sulphur reaction products having in their molecular structure an alkyl radical containing from about 6 to 24 carbon atoms and a radical selected from the group consisting of sulphonic and sulphuric acid ester radicals. More preferred anionic surfactants are the alkali and alkaline earth metal salts of fatty acid carboxylates, fatty alcohol sulphates, preferably primary alkyl sulfates, more preferably they are ethoxylated, for example alkyl ether sulfates; and alkylbenzene sulfonates or mixtures thereof.

Cationic, Amphoteric Surfactants and/or Zwitterionic Surfactants

Preferably the liquid detergency composition according to the invention comprises one or more of cationic, amphoteric surfactants and zwitterionic surfactants.

Preferred cationic surfactants are quaternary ammonium salts of the general formula R₁R₂R₃R₄N⁺ X⁻, for example where R₁ is a C₁₂-C₁₄ alkyl group, R₂ and R₃ are methyl groups, R₄ is a 2-hydroxyethyl group, and X⁻ is a chloride ion. This material is available commercially as Praepagen (Trade Mark) HY from Clariant GmbH, in the form of a 40 wt. % aqueous solution.

Amphoteric surfactants are molecules that contain both acidic and basic groups and will exist as zwitterions at the normal wash pH of between 6 and 11. Preferably the amount of amphoteric or zwitterionic surfactant is from 0.1 to 20 wt. %, more preferably from 0.25 to 15 wt. % and even more preferably from 0.5 to 10 wt. %.

Suitable zwitterionic surfactants are exemplified as those which can be broadly described as derivatives of aliphatic quaternary ammonium, sulfonium and phosphonium compounds with one long chain group having about 8 to about 18 carbon atoms and at least one water solubilizing radical selected from the group consisting of sulfate, sulfonate, carboxylate, phosphate or phosphonate. A general formula for these compounds is:

R₁(R₂)ₓY⁺R₃Z⁻

wherein R₁ contains an alkyl, alkenyl or hydroxyalkyl group with 8 to 18 carbon atoms, from 0 to 10 ethylene-oxy groups or from 0 to 2 glyceryl units; Y is a nitrogen, sulfur or phosphorous atom; R₂ is an alkyl or hydroxyalkyl group with 1 to 3 carbon atoms; x is 1 when Y is a sulfur atom and 2 when Y is a nitrogen or phosphorous atom; R₃ is an alkyl or hydroxyalkyl group with 1 to 5 carbon atoms and Z is a radical selected from the group consisting of sulfate, sulfonate, carboxylate, phosphate or phosphonate.

Preferred amphoteric or zwitterionic surfactants are betaine surfactants. More preferably these are one or more from the following list: Sulfatobetaines, such as 3-(dodecyldimethylammonium)-1-propane sulfate; and 2-(cocodimethylammonium)-1-ethane sulfate. Sulfobetaines, such as: 3-(dodecyldimethyl-ammonium)-2-hydroxy-1-propane sulfonate; 3-(tetradecyl-dimethylammonium)-1-propane sulfonate; 3-(C₁₂-C₁₄ alkyl-amidopropyldimethylammonium)-2-hydroxy-1-propane sulfonate; and 3-(cocodimethylammonium)-1-propane sulfonate. Carboxybetaines, such as (dodecyldimethylammonium) acetate (also known as lauryl betaine); (tetradecyldimethylammonium) acetate (also known as myristyl betaine); (cocodimethylammonium) acetate (also known as coconut betaine); (oleyldimethylammonium) acetate (also known as oleyl betaine); (dodecyloxymethyldimethylammonium) acetate; and (cocoamido-propyldimethylammonium) acetate (also known as cocoamido-propyl betaine or CAPB). Sulfoniumbetaines, such as: (dodecyldimethylsulfonium) acetate; and 3-(cocodimethyl-sulfonium)-1-propane sulfonate. Phosphoniumbetaines, such as 4-(trimethylphosphonium)-1-hexadecane sulfonate; 3-(dodecyldimethylphosphonium)-1-propanesulfonate; and 2-(dodecyldimethylphosphonium)-1-ethane sulfate.

The liquid detergency composition according to the present invention preferably comprise one or more of carboxybetaines or sulphobetaines as amphoteric or zwitterionic surfactants and more preferably comprises lauryl betaine.

### Bleaching Agent

The liquid detergency composition according to the invention preferably comprises bleaching agent. The bleaching agent component for use herein can be any bleaching agents suitable for use in detergency compositions such as oxygen bleaches as well as others known in the art. The bleaching agent can be activated or non-activated bleaching agent.

Preferably the liquid detergency composition according to the invention comprises oxygen bleaching agent, halogen bleaching agent or a combination thereof.

Preferred oxygen bleaching agents are percarboxylic acid bleaching agents and salts thereof and more preferably one or more of magnesium monoperoxyphthalate hexahydrate, the magnesium salt of meta-chloro perbenzoic acid, 4-nonylamino-4-oxoperoxybutyric acid and diperoxydode-canedioic acid or combinations thereof.

Preferably the halogen bleaching agents is one or more of hypohalite bleaching agents, such as trichloro isocyanuric acid and the sodium and potassium dichloroisocyanurates and N-chloro and N-bromo alkane sulphonamides.

Preferably the bleaching agents are added in an amount of from 0.5 to 10 wt. %, more preferably of from 1 to 5 wt. %.

Hydrogen peroxide releasing agents are preferably used in combination with a bleach activators. Preferably the hydrogen peroxide releasing agents is one or more of tetraacetylethylenediamine (TAED), nonanoyloxybenzene-sulfonate, 3, 5,-trimethylhexanoloxybenzenesulfonate (ISONOBS), pentaacetylglucose (PAG), C8(6-octanamido-caproyl)oxybenzenesulfonate, C9(6-nonamido caproyl) oxybenzenesulfonate and C10(6-decanamido caproyl)oxybenzene sulfonate.

### Builder

Preferably the liquid detergency composition according to the invention comprises builder and more preferably comprises one or more of aluminosilicate materials, silicates, polycarboxylates and fatty acids, materials such as ethylenediamine tetraacetate, metal ion sequestrants such as aminopolyphosphonates. Even more preferably, the liquid detergency composition according to the invention comprises zeolite A, citric acid or a combination thereof.

The amount of builder preferably is from 10 to 80 wt. %, more preferably from 20 to 70 wt. % even more preferably from 30 to 60 wt. %.

### Suds Suppressor

Preferably the liquid detergency composition according to the invention comprises suds suppressor and more preferably a silica based suds suppressor, a silicon based suds suppressor or a mixture thereof. Even more preferably the liquid detergency composition according to the invention comprises a mixture of silicone oils and 2-alkylalcanols. The silicones refer to alkylated polysiloxane materials. Silica is preferably used in finely divided forms exemplified by silica aerogels and xerogels and hydrophobic silicas of various types.

Preferably the amount of suds suppressors is from 0.001 to 2 wt. % and more preferably from 0.01 to 1 wt. %.

### Anti Redeposition

Preferably the liquid detergency composition according to the invention comprises one or more anti redeposition agents (also known as a soil suspension agent) of methylcellulose, carboxymethylcellulose and hydroxyethylcellulose, and homo- or co-polymeric polycarboxylic acids or their salts.

Preferably the amount of anti redeposition agent is from 0.5 to 10 wt. %, more preferably from 0.75 to 8 wt. % and even more preferably from 1 to 6 wt. %.

### Soli Release Agent

Preferably the liquid detergency according to the invention comprises one or more soil release agents and more preferably copolymers or terpolymers of terephthalic acid with ethylene glycol and/or propylene glycol units in various arrangements.

### Other Optional Ingredients

The liquid detergency composition may comprise other ingredients commonly found in detergent liquids. Preferably the detergency composition according to the invention comprises one or more of hydrotropes, opacifiers, colorants, perfumes, microcapsules of ingredients such as perfume or care additives, softeners, antioxidants, pH control agents and buffers.

### Detergency Composition Manufacture Process

The liquid detergency composition according to the invention can be made by simply mixing the (liquid and solid) components.

Preferably the liquid detergency composition according to the invention is in the form of a unit-dosed packaged liquid detergency composition. Such unit dosed packages are well-known in the art and typically comprise a water-dissolvable outer-packaging material, which sufficiently disintegrates to enable release of the unit-dosed packaged contents upon contact with sufficient amount of water. A sufficient amount of water for example is an amount of water typically used in a wash-cycle of a standard automated laundry machine. Preferably the wash cycle involves the use of 10 to 100 litres of water involves in combination with 5 to 100 millilitres of liquid detergency composition.

Preferably the unit-dose package comprises from 5 to 100 millilitres of liquid detergency composition. Preferably the unit-dose package comprises and more preferably essentially consists of packaging material which is water-dissolvable.

For non-unit dosed packaging (e.g. a flask of 2-5 litres) the packaging is preferably provided with instructions to agitate the composition before use. These can include for example a ‘shake before use’ instruction. It was found such a direction greatly enhances the activity of the composition during use.

Preferably the liquid detergency composition according to the invention is a liquid laundry composition.

The invention will now be further described with reference to the following non-limiting examples as follows:

### Examples

### Reagents:

Lipase CLEA (Thermomyces lanuginose, Lipase CLEA, Sigma cat#07676)
Lipase (Thermomyces lanuginose lipase, Novozymes))
MTS24-3×laundry liquid in detergent (in house)
Savinase™ 16L (protease, Novozymes)

### Savinase CLEA (Sigma-Aldrich Cat. #41493)

PD-10 Desalting column (GE Healthcare, cat #17-0851-01)
pNP-Palmitate (Sigma cat # N2752)) or pNP-Valerate (Sigma cat # N4377)
Suc-Ala-Ala-Phe-7-Amido-methyl coumarin (Sigma cat # S7388)

### Protocol:

Liquid detergency compositions were made as set out in Table 1. Example 1 (Ex. 1) and Example 2 (Ex. 2) are examples according to the invention. Comparative A (Comp. A) and Comparative B (Comp. B) are not according to the invention.

TABLE 1
Liquid detergency compositions (amounts are based on
wt. % unless otherwise indicated).

| | | | |
|---|---|---|---|
| Ex. 1 | Ex. 2 | Comp. A | Comp. B |

Enzyme combination (Total 0.125 ml)

| | | | | |
|---|---|---|---|---|
| Lipase CLEA | + | − | − | + |
| Lipase (free enzyme) | − | + | + | − |
| Savinase CLEA | − | + | − | + |
| Savinase (free enzyme) | + | − | + | − |

Liquid laundry formulation (Total 2.375 ml)

| | | | | |
|---|---|---|---|---|
| Ethylamine | 7.0 | 7.0 | 7.0 | 7.0 |
| Triethanolamine | 2.5 | 2.5 | 2.5 | 2.5 |
| Monopropylene Glycol | 11.0 | 11.0 | 11.0 | 11.0 |
| Glycerol | 5.0 | 5.0 | 5.0 | 5.0 |
| Citric Acid | 3.9 | 3.9 | 3.9 | 3.9 |
| Bis-(triazinylamino)-stilbene | 0.1 | 0.1 | 0.1 | 0.1 |
| disulfonic acid derivative | | | | |
| Alcohol (C12-C16)poly(7- | 4.6 | 4.6 | 4.6 | 4.6 |
| 19)ethoxylates | | | | |
| Dodecylbenzene Sulfonic | 8.8 | 8.8 | 8.8 | 8.8 |
| Acid | | | | |
| Hydrogenated palm kernel fat | 3.0 | 3.0 | 3.0 | 3.0 |
| 1-hydroxy ethylidene-1,1- | 1.5 | 1.5 | 1.5 | 1.5 |
| diphosphonicacid phosphonic | | | | |
| acid | | | | |
| Sodium Lauryl Ether Sulphate | 6.8 | 6.8 | 6.8 | 6.8 |
| 70% | | | | |
| Polyethyleneimine, | 3.0 | 3.0 | 3.0 | 3.0 |
| ethoxylated | | | | |
| Sodium Sulphite | 0.25 | 0.25 | 0.25 | 0.25 |
| Perfume | 1.4 | 1.4 | 1.4 | 1.4 |
| Water | To | To | To | To |
| | balance | balance | balance | balance |
| Total (enzyme combination + | 2.5 ml | 2.5 ml | 2.5 ml | 2.5 ml |
| liquid laundry formulation) | | | | |

The same amount of enzyme was used in their respective samples.

2.5 ml aliquot of each sample comprising CLEA was first diluted by adding 250 ml of water to disperse the enzyme CLEA. 25 ml of the diluted CLEA sample was collected and the CLEA pellet was washed 3-times with 25 ml water and re-suspended in 5 ml water. For the sample comprising only soluble enzyme a 2.5 ml aliquot of the sample was applied to a PD-10 desalting column and a 3.5 ml enzyme-containing fraction was collected in the flow through fraction. Following these treatments, the lipase and protease residual activities were measured according to the methods below.

Lipase assay: 20 μl of enzyme sample, as prepared in the above paragraph, was added to each well of a standard (96 well) microtitre plate. To each sample 100 μl of 50 mM Tris HCl or Trizma hydrochloride (Sigma #T3253)—NaOH, pH 8.5; 60 μl of water and 20 μl of 1 mM pNP-palmitate or pNP-valerate substrate in 10% methanol, pH 4.5 was further added. The activity was measured by monitoring the release of free 4-nitrophenol at 405 nm over a 15 minute incubation period at room temperature.

### Results

Residual activities were measured (versus a time T0 positive control, which activity is set at 100% and which was directly assayed after preparation of the liquid detergency composition). Residual lipase activity was compared to T0 after a 5 day storage in liquid detergency composition at 37 degrees Celsius. The measurements were repeated 4 times and the average lipase activity averaged and the standard deviation calculated. The results are set-out in Table 2.

TABLE 2
Residual lipase activity.

| | Residual | |
|---|---|---|
| | lipase activity | |
| | | Standard |
| Sample | Average | deviation |
| Comparative 1 (free protease and free lipase) | 12.8 | 1.4 |
| Example 1 (free protease + lipase CLEA) | 99.4 | 4.1 |
| Example 2 (protease CLEA + free lipase) | 106.3 | 6.7 |
| Comparative 2 (lipase CLEA and protease CLEA) | <1.0 | 1.4 |

What can be seen from the results is that if either the protease or the non-protease enzyme is in the form of a CLEA than the activity of the non-protease enzyme (in this case a lipase) suffers little or no affect the during 5 day storage condition (Example 1, Example 2). The improvement is made clear when compared to the situation wherein both the enzymes are in the form of CLEAs or when both are in free (soluble) form (Comparative A, Comparative B).

1. A liquid detergency composition comprising:
protease and non-protease enzyme wherein at least part of either the protease or the non-protease enzyme is cross-linked enzyme aggregate.

2. A liquid detergency composition according to claim 1, comprising from 0.01 to 6 wt. %, preferably from 0.1 to 5 wt. %, more preferably from 0.2 to 4 wt. %, even more preferably from 0.5 to 3 wt. % and still even more preferably from 0.7 to 2.0 wt. % of protease.

3. A liquid detergency composition according to claim 1, wherein the protease comprises Savinase™, Coronase™, Relase™ or mixtures thereof, and preferably essentially is Relase™.

4. A liquid detergency composition according to claim 1, wherein the non-protease enzyme comprises one or more of enzymes of lipase, amylase, phospholyase, cutinase, cellulose, peroxidise, oxidase, pectate lyase and mannose enzymes.

5. A liquid detergency composition according to claim 1, wherein the non-protease enzyme comprises from 0.01 to 6 wt. %, preferably from 0.1 to 5 wt. %, more preferably from 0.2 to 4 wt. %, even more preferably from 0.5 to 3 wt. % and still even more preferably from 0.7 to 2.0 wt. % of lipase, based of the total weight of the composition.

6. A liquid detergency composition according to claim 1, comprising cross-linked enzyme aggregate of non-protease enzyme, wherein at least 25 wt. %, preferably at least 50 wt. %, more preferably 75 wt. % and even more preferably essentially all of the non-protease enzyme, based on the total weight of the non-protease enzyme, is in the form of cross-linked enzyme aggregate.

7. A liquid detergency composition according to claim 1, comprising cross-linked enzyme aggregate of protease, wherein at least 25 wt. %, preferably at least 50 wt. %, more preferably 75 wt. % and even more preferably essentially all of the protease, based on the total weight of the protease, is in the form of cross-linked enzyme aggregate.

8. A liquid detergency composition according to claim 1, wherein the detergency composition is ambient-active.

9. A liquid detergency composition according to claim 1, comprising a detersive surfactant, preferably a anionic surfactant, nonionic surfactant or a mixture thereof and more preferably a mixture of anionic and nonionic surfactants.

10. A liquid detergency composition according to claim 1, comprising an oxygen bleaching agent, a halogen bleaching agent or a combination thereof.

11. A liquid detergency composition according to claim 1, comprising aluminosilicate materials, silicates, polycarboxylates and fatty acids, materials such as ethylenediamine tetraacetate, metal ion sequestrants such as aminopolyphosphonates or a combination thereof, and more preferably comprises zeolite A, citric acid or a combination thereof.

12. A liquid detergency composition according to claim 1, comprising suds suppressor and preferably a silica based suds suppressor, a silicon based suds suppressor or a mixture thereof.

13. A liquid detergency composition according to claim 1, comprising one or more of methylcellulose, carboxymethylcellulose and hydroxyethylcellulose, and homo- or co-polymeric polycarboxylic acids or their salts; and combinations thereof.

14. A liquid detergency composition according to claim 1, wherein the composition is packaged in the form of a unit-dosed package.

15. A liquid detergency composition according to claim 1, wherein the liquid detergency composition is a liquid laundry composition.
